(19) United States
(12) Patent Application Publication
(10) Pub. No.: US 2026/0317609 A1
(43) Pub. Date: Oct. 15, 2026

(54) FILLING CONTAINER AND STORAGE METHOD THEREFOR

(71) Applicant: AGC INC., Tokyo (JP)

(72) Inventors: Susumu SUGIMOTO, Tokyo (JP); Kenya KASUGA, Tokyo (JP); Takayuki SAKAI, Tokyo (JP)

(73) Assignee: AGC INC., Tokyo (JP)

(21) Appl. No.: 19/464,567

(22) Filed: Jan. 29, 2026

Related U.S. Application Data
(63) Continuation of application No. PCT/JP2024/024675, filed on Jul. 9, 2024.

(30) Foreign Application Priority Data
Aug. 4, 2023 (JP) 2023-128095

(51) Int. Cl. C09K 5/04; F17C 1/00

(52) U.S. Cl. CPC C09K 5/045; F17C 1/00; C09K 2205/126; C09K 2205/22; F17C 2201/058; F17C 2221/038

(57) ABSTRACT

There are provided a filled container which suppresses disproportionation reaction of HFO such as trifluoroethylene and can be transported and stored safely, and a method for storing the filled container. The filled container of the present invention has a composition comprising a first component and a second component, and a container filled with the composition, wherein the first component is at least one selected from the group consisting of trifluoroethylene, 1,2-difluoroethylene and 1,1-difluoroethylene; the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen; an amount of the first component with respect to a sum amount of the first component and the second component is 62.6% by mass or less; and the container is composed of a material having a tensile strength of 400 N/mm² or more and a yield ratio of 60% or more.

### TECHNICAL FIELD

The present invention relates to a filled container containing a predetermined hydrofluoroolefin, and a method for storing the same.

### BACKGROUND ART

Since chlorofluorocarbons (CFC) and hydrochlorofluorocarbons (HCFC), which have been used in applications (hereinafter, these applications are simply generically called refrigerants in some cases), such as refrigerants for refrigerators and air conditioners, working media for thermal cycle for power generation systems, heat pipes and the like, solvents and detergents, have high ozone layer depletion potentials (ODP), as an alternative medium thereto, hydrofluorocarbons (HFC) have been developed.

Also HFC, however, have become a regulatory target as a causative substance of global warming, and conversion to refrigerants including hydrofluorolefins (HFO) lower in the global warming potential (GWP) is demanded. Among the HFO, trifluoroethylene (HFO-1123), although being very low in the GWP and ODP and promising as a next-generation medium, causes disproportionation reaction under the conditions of high temperature, high pressure and the presence of an ignition source. On propagation of disproportionation reaction due to layer short and the like in refrigerant compressors, a sharp rise in temperature and pressure can result in accidents by breakage of the refrigerant compressors.

For example, PTLI states that for suppression of such disproportionation reaction, a composition having a content of trifluoroethylene of 70% by mol or less which is made by mixing it with an inactive substance is effective as a working medium, and the working medium can be used stably in the presence of an ignition source.

### CITATION LIST

### Patent Literature

PTL1: WO2015/115551

### SUMMARY OF INVENTION

### Technical Problem

However, HFO, liable to be disproportionated, such as trifluoroethylene, 1,2-difluoroethylene (HFO-1132) and 1,1-difluoroethylene (HFO-1132a), even in the absence of an ignition source, when being stored and transported in a filled container, causes disproportionation reaction by strong shocks from outside the container in some cases.

In effect, the shock energy received from outside the filled container in storage or transportation is supposed to be larger than a minimum ignition energy caused by an ignition source in use of a refrigerant. Hence, it is concerned that HFO, liable to be disproportionated, including trifluoroethylene, causes disproportionation reaction in storage or transportation of the filled container.

Accordingly, for HFO such as trifluoroethylene, from the viewpoint of safe handling, suppression of the disproportionation reaction in a filled container having no ignition source present is demanded.

The present invention has been achieved under such a situation, and has an object to provide a filled container which suppresses disproportionation reaction of HFO such as trifluoroethylene and can be transported and stored safely, and a method for storing the filled container.

### Solution to Problem

The present invention is based on the finding that a filled container for a composition having HFO such as trifluoroethylene blended with a predetermined component is effective for suppression of disproportionation reaction.

The present invention provides the following means.

[1] A filled container comprising a composition comprising a first component and a second component, and a container filled with the composition, wherein the first component is at least one selected from the group consisting of trifluoroethylene, 1,2-difluoroethylene and 1,1-difluoroethylene; the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen; an amount of the first component with respect to a sum amount of the first component and the second component is 62.6% by mass or less; and the container is composed of a material having a tensile strength of 400 N/mm² or more and a yield ratio of 60% or more.

[2] The filled container according to [1], wherein the sum amount of the first component and the second component relative to a total amount of the composition is 90.0% by mass or more.

[3] The filled container according to [1] or [2], wherein the amount of the first component relative to the total amount of the composition is 40.0% by mass or more.

[4] The filled container according to any one of [1] to [3], wherein the first component is trifluoroethylene.

[5] The filled container according to any one of [1] to [4], wherein the second component is at least one selected from the group consisting of 2,3,3,3-tetrafluoropropene and difluoromethane.

[6] The filled container according to any one of [1] to [5], wherein a yield strength of the container is 255 N/mm² or more.

[7] The filled container according to any one of [1] to [6], wherein an internal volume of the container is 5 L or more.

[8] The filled container according to any one of [1] to [7], wherein a wall thickness of the container is 2.5 mm or more.

[9] The filled container according to any one of [1] to [8], wherein an internal pressure of the filled container is 6.0 MPa or less.

[10] The filled container according to any one of [1] to [9], wherein an internal temperature of the filled container is 60 °C or less.

[11] A method for storing a filled container comprising a composition comprising a first component and a second component, and a container filled with the composition, wherein the first component is at least one selected from the group consisting of trifluoroethylene, 1,2-difluoroethylene and 1,1-difluoroethylene; the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen; an amount of the first component with respect to a sum amount of the first component and the second component is 62.6% by mass or less; and the container is composed of a material having a tensile strength of 400 N/mm² or more and a yield ratio of 60% or more.

### Advantageous Effects of Invention

According to the present invention, there are provided a filled container which suppresses disproportionation reaction of HFO such as trifluoroethylene, and a method for storing the filled container. Accordingly, the filled container of the present invention is effective for safe transportation and storage of HFO,

### DESCRIPTION OF EMBODIMENTS

Definitions and meanings of terms and representations in the present description are described below.

A preferable numerical range can be an optional combination of a preferable lower limit value and a preferable upper limit value.

A halogenated hydrocarbon is represented by a trivial name based on the kind and the refrigerant number in some cases. Then, in HFO which can have a geometric isomer, the expression of the compound having no description of E-isomer and Z-isomer means a generic name including E-isomer, Z-isomer and a mixture of E-isomer and Z-isomer.

The filled container of the present invention is a filled container having a composition comprising a first component and a second component, and a container filled with the composition, wherein the first component is at least one selected from the group consisting of trifluoroethylene, 1,2-difluoroethylene and 1,1-difluoroethylene; the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen; an amount of the first component with respect to a sum amount of the first component and the second component is 62.6% by mass or less; and the container is composed of a material having a tensile strength of 400 N/mm² or more and a yield ratio of 60% or more,

Such a filled container, in transport, storage and the like thereof, suppresses disproportionation reaction of HFO of the first component, and in its turn, dangers such as explosion caused by the disproportionation reaction are suppressed. Specifically, the present invention provides a filled container of HFO whose safety has been confirmed fully in an impact test (test in accordance to an acetylene cylinder porous mass performance test based on High Pressure Gas Safety Act) in Examples described later. That is, the filled container of the present invention can suppress disproportionation reaction of HFO by shock energy not in the state that any ignition source in a thermal cycle system or the like is present but in transportation, storage and the like of the container filled with HFO in whose internal space no ignition source is present.

Then, in the present invention, from the viewpoint of safety in the transportation and storage, in the impact test in Examples, the case where the internal pressure of a filled container during the test or right after the test rises to 1.5 or more times the internal pressure thereof before the test is regarded as disproportionation reaction having occurred. Further, recognition of black foreign matter in the interior of the container after the impact test, and recognition of a rise in the hydrogen fluoride concentration (in Examples, detection as fluoride ion concentration) in a gas in the interior of the container after the impact test may be collectively used as a criterium of occurrence of disproportionation reaction.

### COMPOSITION

The composition filled in the filled container of the present invention contains the first component and the second component.

The first component is at least one selected from the group consisting of trifluoroethylene (HFO-1123), 1,2-difluoroethylene (HFO-1132a) and 1,1-difluoroethylene (HFO-1132). The first component is these HFO, and may contain one kind thereof singly, or may contain two or more kinds thereof. In a preferred embodiment of the present invention, the first component is trifluoroethylene.

The second component is at least one selected from the group consisting of 2,3,3,3-tetrafluoropropene (HFO-1234yf), difluoromethane (HFC-32), fluoromethane (HFC-41), 1,1-difluoroethane (HFC-152a), fluoroethane (HFC-161), 1,1,1,3,3-pentafluorobutane (HFC-365mfc), dimethyl ether, carbon dioxide, propane, butane, argon, helium, and nitrogen. The second component may contain one kind thereof singly, or may contain two or more kinds thereof. In a preferred embodiment of the present invention, the second component is at least one selected from the group consisting of 2,3,3,3-tetrafluoropropene and difluoromethane, and more preferably, the second component is 2,3,3,3-tetrafluoropropene.

The composition contains the first component and the second component, and an amount of the first component with respect to a sum amount of the first component and the second component is 62.6% by mass or less, and preferably 62.5% by mass or less and more preferably 62.1% by mass or less. Then, from the viewpoint of the transportation efficiency of HFO of the first component, and the like, the amount of the first component is preferably 50.0% by mass or more, more preferably 53.0% by mass or more and still more preferably 55.0% by mass or more.

The content of the first component in the total amount of the composition is, from the viewpoint of the transportation efficiency of HFO of the first component, preferably 40.0% by mass or more, more preferably 45.0% by mass or more, still more preferably 50.0% by mass or more and further still more preferably 55.0% by mass or more. Then, from the viewpoint of sufficient suppression of disproportionation reaction of the first component, the upper limit of the content of the first component in the total amount of the composition is preferably 62.6% by mass or less, more preferably 62.5% by mass or less and still more preferably 62.1% by mass or less.

The amount of the second component is, with respect to the sum amount of the first component and the second component, 37.4% by mass or more, and preferably 37.5% by mass or more and more preferably 37.9% by mass or more. Then, from the viewpoint of the transportation efficiency of HFO of the first component, and the like, the amount of the second component is preferably 50.0% by mass or less, more preferably 47.0% by mass or less and still more preferably 45.0% by mass or less.

The content of the second component in the total amount of the composition is, from the viewpoint of sufficient suppression of disproportionation reaction of the first component, preferably 37.4% by mass or more, more preferably 37.5% by mass or more and still more preferably 37.9% by mass or more. Then, the upper limit of the content of the second component in the total amount of the composition is, from the viewpoint of the transportation efficiency of HFO of the first component, preferably 60.0% by mass or less, more preferably 55.0% by mass or less, still more preferably 50.0% by mass or less and further still more preferably 45% by mass or less.

The composition may contain other components other than the first component and the second component. The other components may be added, and can be contained as impurities.

In the case of containing the other components, from the viewpoint of sufficient suppression of disproportionation reaction and the transportation efficiency of the first component, and the like, the sum amount of the first component and the second component with respect to the total amount of the composition is preferably 90.0% by mass or more, more preferably 95.0% by mass or more and still more preferably 99.0% by mass or more.

That is, the content of the other components in the total amount of the composition is preferably 10.0% by mass or less, more preferably 5.0% by mass or less and still more preferably 1.0% by mass or less, and may also be 0% by mass. In a preferred embodiment of the present invention, the sum amount of the first component and the second component relative to the total amount of the composition is 100% by mass.

Here, the content of each component in the composition, unless otherwise specified, can be measured by gas chromatography.

Examples of the other components which may be added include HFO other than the first component and the second component, HFC, hydro chlorofluoroolefin (HCFO), chlorofluoroolefin (CFO), other halogen compounds and hydrocarbon compounds. The other components may be used in one kind thereof singly, or may be used in two or more kinds thereof.

Examples of the HFO include 2-fluoropropene (HFO-1261yf), 1,1,2-trifluoropropene (HFO-1243yc), 1,3,3,3-tetrafluoropropene (HFO-1234ze), 1,2,3,3,3-pentafluoropropene (HFO-1225ye), 3,3,3-trifluoropropene (HFO-1243zf), and 1,1,1,4,4,4-hexafluorobutene (HFO-1336mzz).

Examples of HFC include 1,1,1-trifluoroethane (HFC-143a), 1,1,2,2-tetrafluoroethane (HFC-134), 1,1,1,2-tetrafluoroethane (HFC-134a), pentafluoroethane (HFC-125), 1,1,1,3,3-pentafluoropropane (HFC-245fa), 1,1,1,3,3,3-hexafluoropropane (HFC-236fa), and 1,1,2,2,3,3,4-heptafluorocyclopentane (HFC-c 447ef).

Examples of HCFO include 1-chloro-2,3,3,3-tetrafluoropropene (HCFO-1224yd), 2-chloro-1,1,3,3-tetrafluoropropene (HCFO-1224xc), 2-chloro-1,3,3,3-tetrafluoropropene (HCFO-1224xe), 1-chloro-1,2-difluoroethylene (HCFO-1122), 1-chloro-3,3,3-trifluoropropene (HCFO-1233zd), 2-chloro-1,1,3-trifluoropropene (HCFO-1233xc), and 2-chloro-3,3,3-trifluoropropene (HCFO-1233xf).

Examples of CFO include 1,1-dichloro-2,3,3,3-tetrafluoropropene (CFO-1214ya), 1,3-dichloro-1,2,3,3-tetrafluoropropene (CFO-1214yb), and 1,2-dichloro-1,2-difluoroethylene (CFO-1112).

Examples of the other halogen compounds include iodine compounds and bromine compounds such as iodomethane (CH₃I), diiodomethane (CH₂I₂), dibromomethane (CH₂Br₂), bromomethane (CH₃Br), dichloromethane (CH₂Cl₂), chloroiodomethane (CH₂CII), dibromochloromethane (CHBr₂Cl), tetraiodomethane (Cl₄), tetrabromomethane (CBr₄), bromotrichloromethane (CBrCl₃), dibromodichloromethane (CBr₂Cl₂), tribromofluoromethane (CBr₃F), fluoroiodomethane (CH₂FI), difluoroiodomethane (CHF₂I), difluorodiiodomethane (CF₂I₂), dibromodifluoromethane (CBr₂F₂), trifluoroiodomethane (CF₃I), and 1,1,1-trifluoro-2-iodoethane (CF₃CH₂I).

Examples of the hydrocarbon compounds include cyclopropane, isobutane, pentane, and isopentane.

Examples of the other components which may be contained as impurities include by-products in the production of the first component and the second component, and inevitable components such as solvents to be used. The content of the other components which may be contained as impurities, in consideration of the simplification and the removal limit of purification processes of the first component and the second component, in the total amount of the composition, may be 50 ppm by mass or more, and may be 100 ppm by mass or more. The content of the other components which may be contained as impurities of is, from the viewpoint of securing the safety in transportation and storage of the filled container, and the like, in the total amount of the composition, preferably 1.0% by mass or less, more preferably 0.5% by mass or less and still more preferably 0.1% by mass or less.

The other components which may be contained as impurities include hydrogen fluoride, methane, chloromethane, dichlorodifluoromethane (CFC-12), 1,1,2-trichloro-1,2,2-trifluoroethane (CFC-113), chlorodifluoromethane (HCFC-22), chlorofluoromethane (HCFC-31), 2,2-dichloro-1,1,1-trifluoroethane (HCFC-123), 1,2-dichloro-1,1,2-trifluoroethane (HCFC-123a), 2-chloro-1,1,1,2-tetrafluoroethane (HCFC-124), 1-chloro-1,1,2,2-tetrafluoroethane (HCFC-124a), 1-chloro-1,2,2-trifluoroethane (HCFC-133), 2-chloro-1,1,1-trifluoroethane (HCFC-133a), 1-chloro-1,1,2-trifluoroethane (HCFC-133b), 2-chloro-1,1-difluoroethane (HCFC-142), 1-chloro-1,1-difluoroethane (HCFC-142b), trifluoromethane (HFC-23), pentafluoroethane (HFC-125), 1,1,2,2-tetrafluoroethane (HFC-134), 1,1,1,2-tetrafluoroethane (HFC-134a), 1,1,2-trifluoroethane (HFC-143), 1,1,1-trifluoroethane (HFC-143a), 1,1,1,2,2,3,3-heptafluoropropane (HFC-227ca), 1,1,1,2,3,3,3-heptafluoropropane (HFC-227ea), 1,1,1,3,3,3-hexafluoropropane (HFC-236fa), 1,1,1,2,3,3-hexafluoropropane (HFC-236ea), fluoroethylene (HFO-1141), 1,1,3,3,3-pentafluoropropene (HFO-1225zc), 1,3,3,3-tetrafluoropropene (HFO-1234ze), 3,3,3-trifluoropropene (HFO-1243zf), 3,3-difluoropropene (HFO-1252zf), 1-chloro-2,2-difluoroethylene (HCFO-1122), 1-chloro-1,2-difluoroethylene (HCFO-1122a), 1-chloro-2-fluoroethylene (HCFO-1131), 1,2-dichloro-1,2-difluoroethylene (CFO-1112), chlorotrifluoroethylene (CFO-1113), tetrafluoroethylene (FO-1114), hexafluoropropene (FO-1216), and perfluorocyclobutane (FC-318).

Further, components which may be contained as impurities include water and oxygen. In the case where water is contained in the composition, the content of water is, from the viewpoint of suppression of disproportionation reaction of the first component, in the total amount of the composition, preferably 1,000 ppm by mass or less, more preferably 500 ppm by mass or less, still more preferably 100 ppm by mass or less and further still more preferably 50 ppm by mass or less. Then, from the viewpoint of reduction of the operation and the cost burden required for removal of water in the composition, the lower limit of the content of water in the total amount of the composition may be 0.1 ppm by mass or more and may be 1 ppm by mass or more.

Here, the content of water in the composition can be measured by a Karl Fischer moisture meter.

In the case where oxygen is contained in the composition, the content of oxygen is, from the viewpoint of suppression of disproportionation reaction of the first component, in the total amount of the composition, preferably 1,000 ppm by mass or less, more preferably 500 ppm by mass or less, still more preferably 100 ppm by mass or less and further still more preferably 50 ppm by mass or less. Then, from the viewpoint of reduction of the operation and the cost burden required for removal of oxygen in the composition, the lower limit of the content of oxygen in the total amount of the composition may be 0.1 ppm by mass or more and may be 1 ppm by mass or more.

### Container

The container in the filled container of the present invention is composed of a material having a tensile strength of 400 N/mm² or more and a yield ratio of 60% or more.

The container is not limited in the structure and the material as long as being capable of filling and enclosing the composition under an internal pressure. Examples of the container include pressure-resistant vessels such as storage tanks and cylinders.

Then, the container in the present invention is a container on condition that the composition in the state of being filled inside the container is made not to exhibit the predetermined function as a refrigerant, a heating medium or the like. Specifically, the container in the present invention does not include freezing and cold storage equipment (built-in type showcases, separate type showcases, business-use freezing and cold storage chambers, automatic vending machines, icemakers and the like), air-conditioning equipment (room air conditioners, package air conditioners for stores, package air conditioners for buildings, package air conditioners for facilities, gas engine heat pumps, air conditioners for trains, air conditioners for automobiles, and the like), power generation systems (waste-heat recovery power generation and the like), heat transport equipment (heat pipes and the like), secondary cooling machines, and the like.

The container in the present invention has no ignition source in the internal space of the container in which the composition is filled.

Examples of the structure of the container include one which has a cylindrical barrel part and on each end of the barrel part, a lid part, and is so formed that the interior of the container is put in a sealed state. The barrel part and the lid parts may be formed of different members, or may be formed in one united body.

Examples of the material of the container include carbon steel, manganese steel, chrome molybdenum steel, other low alloy steels, stainless steel, aluminum alloys, copper, iron, aluminum, nickel, titanium, metal silicon, silicon steel, tin, magnesium, and zinc. The material may be in one kind thereof singly, or may be in two or more kinds thereof. In a preferred embodiment of the present invention, the material of the container to be used is steel for a high-pressure gas container prescribed in JIS G 3116: 2020.

The tensile strength and the yield strength of the container in the present invention are measurement values of a constituent material of the barrel part of the container measured according to JIS Z 2241: 2011(based on ISO 6892-1) quoted in JIS G 3116: 2020. A test piece in a tensile test to be used is a No. 5 test piece of JIS Z 2241: 2011. The measurement is carried out in air at the ambient temperature (25 °C); in the tensile test carried out, the maximum stress during uniform elongation is taken as the tensile strength, and the 0.2% proof stress is taken as the yield strength. The yield ratio is calculated from a ratio of the yield strength to the tensile strength.

The tensile strength of the container is, in consideration of the safety in handling of the filled container, 400 N/mm² or more, and preferably 440 N/mm² or more, more preferably 490 N/mm² or more and still more preferably 540 N/mm² or more. Then, from the viewpoint of practical use, the tensile strength of the container is preferably 1,100 N/mm² or less, more preferably 1,000 N/mm² or less and still more preferably 900 N/mm² or less.

The yield ratio of the container is, in consideration of the safety in handling of the filled container, 60% or more, and preferably 63% or more, more preferably 66% or more and still more preferably 67% or more. Then, from the viewpoint of practical use, the yield ratio of the container is preferably 90% or less and more preferably 85% or less.

The yield strength of the container is, in consideration of the safety in handling of the filled container, preferably 255 N/mm² or more, more preferably 295 N/mm² or more, still more preferably 325 N/mm² or more and further still more preferably 365 N/mm² or more.

The internal volume of the container is, from the viewpoint of the transportation efficiency of the filled container, and the like, preferably 5 L or more, more preferably 7.5 L or more and still more preferably 10 L or more. Then, from the viewpoint of practical use, the internal volume of the container is preferably 1,300 L or less, more preferably 500 L or less, still more preferably 100 L or less, further still more preferably 50 L or less and further still more preferably 20 L or less.

In consideration of the pressure resistance of the filled container, and the like, the larger the wall thickness of the container, the better, and the wall thickness is preferably 2.5 mm or more and more preferably 2.7 mm or more. Then, from the viewpoint of the transportation efficiency of the filled container and the production efficiency of the container, the wall thickness of the container is preferably 23.0 mm or less, more preferably 10.0 mm or less, still more preferably 8.0 mm or less, further still more preferably 5.0 mm or less and further still more preferably 3.5 mm or less.

The wall thickness of the container in the present invention is a measurement value in the barrel part of the container.

The internal pressure of the filled container is, from the viewpoint of suppression of disproportionation reaction of the first component, preferably 6.0 MPa or less, more preferably 3.6 MPa or less and still more preferably 3.0 MPa or less. Then, from the viewpoint of the transportation efficiency of the filled container, the internal pressure is preferably 1.0 MPa or more and more preferably 1.5 MPa or more.

Here, the internal pressure of the container in the present invention is a gage pressure.

The internal temperature of the filled container is, from the viewpoint of suppression of disproportionation reaction of the first component, preferably 60 °C or less, more preferably 50 °C or less and still more preferably 40 °C or less. Then, from the viewpoint of easiness in handling of the filled container, the internal temperature of the filled container is preferably 5 °C or more, more preferably 10 °C or more and still more preferably 15 °C or more.

### Storage Method

The method for storing a filled container of the present invention is a method for storing a filled container having a composition comprising a first component and a second component, and a container filled with the composition, wherein the first component is at least one selected from the group consisting of trifluoroethylene, 1,2-difluoroethylene and 1,1-difluoroethylene; the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen; an amount of the first component with respect to a sum amount of the first component and the second component is 62.6% by mass or less; and the container is composed of a material having a tensile strength of 400 N/mm² or more and a yield ratio of 60% or more.

That is, the method for storing the filled container of the present invention is characterized in storing the first component and the second component in a form of the above-mentioned filled container of the present invention. According to such a storage method, HFO of the first component can be stored safely in the state that the disproportionation reaction is suppressed.

The filled container in the storage method is the same as the above-mentioned filled container of the present invention, so the interpretation thereof will be omitted.

Here, “storage” used in the present invention includes storage at places, not limited to places where a composition is filled in a container to produce a filled container, where the filled container is used, and storage at temporary storage places (for example, storehouses) before and after transportation to usage places, and in transportations (for example, in the state of being fixed in transport vehicles and transport ships), and storage at other places.

Examples Hereinafter, the present invention will be described specifically by way of Examples, but the present invention is not limited to the following Examples. Cases 1 to 3 are Examples, and Case 4 is Comparative Example.

### Case 1

A filled container (amount filled: 2.49 kg, container internal pressure: 2.0 MPa, internal temperature: 30 °C) was prepared in which a mixture (composition) of trifluoroethylene (HFO-1123) and 2,3,3,3-tetrafluoropropene (HFO-1234yf) in a mass ratio of 56.1/43.9 was filled in a high-pressure gas container (material: SG 365 steel, tensile strength: 540N/mm² , yield strength: 365N/mm² , yield ratio: 68%) of 12.5 L in internal volume and 2.8 mm in wall thickness.

The filled container was subjected to the following impact test and evaluated.

According to an acetylene container porous material performance test based on High Pressure Gas Safety Act, an explosion impact was given to the filled container. The maximum pressure reached of the internal pressure of the filled container at this time was measured and the interior of the container after the test was observed with a fiber scope camera. Then, the contents in the container after the test were subjected to a composition analysis using gas chromatography. Further, gases in the interior of the container before and after the test were, respectively, made to flow through a sodium bicarbonate water of 7.9% by mass in concentration, and subjected to a measurement of the fluoride ion concentration using gas chromatography to check the presence/absence of a rise in the fluoride ion concentration in the gas in the interior of the container after the test.

The maximum pressure reached of the filled container of Case 1 in the test was 2.0 MPa; no abnormality in the interior of the container after the test was confirmed; and no remarkable compositional change in the composition was recognized.

Since the filled container of Case 1 exhibited no change in the internal pressure by the impact in the test, no remarkable compositional change of the composition, and no recognized rise in the fluoride ion concentration of the gas in the interior of the container after the test, it can be said that no disproportionation reaction of trifluoroethylene occurred and the safety to the impact was verified.

### Case 2

A filled container (amount filled: 2.46 kg, container internal pressure: 2.0 MPa, internal temperature: 33 °C) was prepared in which a mixture (composition) of trifluoroethylene (HFO-1123) and 2,3,3,3-tetrafluoropropene (HFO-1234yf) in a mass ratio of 62.1/37.9 was filled in a high-pressure gas container (material: the same as in Case 1) of 12.5 L in internal volume and 3.4 mm in wall thickness, and was subjected to the impact test as in Case 1.

The maximum pressure reached of the filled container of Case 2 in the test was 2.2 MPa; no abnormality in the interior of the container after the test was confirmed; and no remarkable compositional change in the composition was recognized.

Although the internal pressure of the filled container of Case 2 rose to 1.1 times (by 0.2 MPa) by the impact in the test, since the filled container of Case 2 exhibited no remarkable compositional change of the composition, and no recognized rise in the fluoride ion concentration of the gas in the interior of the container after the test, it can be said that no disproportionation reaction of trifluoroethylene occurred and the safety to the impact was verified.

### Case 3

A filled container (amount filled: 2.36 kg, container internal pressure: 2.6 MPa, internal temperature: 35 °C) was prepared in which a mixture (composition) of trifluoroethylene (HFO-1123) and difluoromethane (HFC-32) in a mass ratio of 62.6/37.4 was filled in a high-pressure gas container (material: the same as in Case 1) of 12.5 L in internal volume and 3.4 mm in wall thickness, and was subjected to the impact test as in Case 1.

The maximum pressure reached of the filled container of Case 3 in the test was 2.6 MPa; no abnormality in the interior of the container after the test was confirmed; and no remarkable compositional change in the composition was recognized.

Since the filled container of Case 3 exhibited no change in the internal pressure by the impact in the test, no remarkable compositional change of the composition, and no recognized rise in the fluoride ion concentration of the gas in the interior of the container after the test, it can be said that no disproportionation reaction of trifluoroethylene occurred and the safety to the impact was verified.

### Case 4

A filled container (amount filled: 2.20 kg, container internal pressure: 1.8 MPa, internal temperature: 20 °C) was prepared in which a mixture (composition) of trifluoroethylene (HFO-1123) and difluoromethane (HFC-32) in a mass ratio of 62.7/37.3 was filled in a high-pressure gas container (material: the same as in Case 1) of 12.5 L in internal volume and 3.4 mm in wall thickness, and was subjected to the impact test as in Case 1.

The pressure of the filled container of Case 4 in the test exceeded the upper limit, 25 MPa, of the measurable range of a pressure gauge; and the presence of black foreign matter in the interior of the container after the test was confirmed. In the gas in the interior of the container after the test, the fluoride ion concentration rose by 3.5 mg/L. For the filled container of Case 4, as circumstantially judged from the remarkable rise in the internal pressure by the impact in the test, the presence of the foreign matter in the interior of the container after the test, and the rise in the fluoride ion concentration, it is presumed that the disproportionation reaction of trifluoroethylene occurred.

Then, as compounds to be mixed with trifluoroethylene (HFO-1123), there are known, as compounds constituting mixtures more hardly causing the disproportionation reaction by ignition than the mixture with difluoromethane (HFC-32), fluoromethane (HFC-41), 1,1-difluoroethane (HFC-152a), fluoroethane (HFC-161), 1,1,1,3,3-pentafluorobutane (HFC-365mfc), dimethyl ether, carbon dioxide, propane, butane, argon, helium, and nitrogen, (see Journal of Loss Prevention in the Process Industries, 2018, Vol. 54, p. 179-182). From this, it can be said that these compounds other than 2,3,3,3-tetrafluoropropene (HFO-1234yf) and difluoromethane (HFC-32) can also be used as effective second components for suppression of the disproportionation reaction of HFO of the first component.

1. A filled container comprising a composition comprising a first component and a second component, and a container filled with the composition,
wherein the first component is at least one selected from the group consisting of trifluoroethylene, 1,2-difluoroethylene and 1,1-difluoroethylene;
the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen;
an amount of the first component with respect to a sum amount of the first component and the second component is 62.6% by mass or less; and
the container is composed of a material having a tensile strength of 400 N/mm² or more and a yield ratio of 60% or more.

2. The filled container according to claim 1, wherein the sum amount of the first component and the second component relative to a total amount of the composition is 90.0% by mass or more.

3. The filled container according to claim 1, wherein the amount of the first component relative to the total amount of the composition is 40.0% by mass or more.

4. The filled container according to claim 1, wherein the first component is trifluoroethylene.

5. The filled container according to claim 1, wherein the second component is at least one selected from the group consisting of 2,3,3,3-tetrafluoropropene and difluoromethane.

6. The filled container according to claim 1, wherein a yield strength of the container is 255 N/mm² or more.

7. The filled container according to claim 1, wherein an internal volume of the container is 5 L or more.

8. The filled container according to claim 1, wherein a wall thickness of the container is

2. 5 mm or more.

9. The filled container according to claim 1, wherein an internal pressure of the filled container is 6.0 MPa or less.

10. The filled container according to claim 1, wherein an internal temperature of the filled container is 60°C or less.

11. A method for storing a filled container comprising a composition comprising a first component and a second component, and a container filled with the composition,
wherein the first component is at least one selected from the group consisting of trifluoroethylene, 1,2-difluoroethylene and 1,1-difluoroethylene;
the second component is at least one selected from the group consisting of 2,3,3,3-tetrafluoropropene, difluoromethane, fluoromethane, 1,1-difluoroethane, fluoroethane, 1,1,1,3,3-pentafluorobutane, dimethyl ether, carbon dioxide, propane, butane, argon, helium, and nitrogen;
an amount of the first component with respect to a sum amount of the first component and the second component is 62.6% by mass or less; and
the container is composed of a material having a tensile strength of 400 N/mm² or more and a yield ratio of 60% or more.
